(19) United States
(12) Patent Application Publication
(10) Pub. No.: US 2008/0146137 A1
(43) Pub. Date: Jun. 19, 2008

(54) Multi Purpose Refrigerated Box Hold and Container Cargo Carrier with One or More Cargo Holds

(76) Inventor: Mark Anthony Mosunic, Foothill Ranch, CA (US)

Correspondence Address: JOHN K. BUCHE, 7777 FAY AVENUE, SUITE 205, LA JOLLA, CA, 92037, US

(21) Appl. No.: 11/957,250

(22) Filed: Dec. 14, 2007

Related U.S. Application Data
(60) Provisional application No. 60/870,581, filed on Dec. 18, 2006.

(51) Int. Cl. B60H 1/32; F25D 17/00; F24F 3/12; B23P 19/04; B63B 25/00; F24F 3/16; B60P 3/20

(52) U.S. Cl. 454/118; 62/56; 62/62; 62/78; 29/428; 114/72

(57) ABSTRACT

A multi-purpose cargo hold, carrier vessel, and shipping methods for circulating conditioned air through multiple levels and types of cargo situated therein. Disclosed are apparatus and methods for shipping and conditioning air surrounding cargo on a carrier vessel comprising the steps of loading cargo onto a loading means; forming a plurality of air gaps throughout the cargo in the cargo hold; placing supply and return air plenums in fluid communication with one another; and delivering and circulating conditioned air to cargo via an air conditioning means.

This application claims priority and the benefit of provisional application Ser. No. 60/870,581 filed on Dec. 18, 2006.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

The present application is in the field of multipurpose refrigerated cargo holds, and container carriers having one or more cargo holds.

2. Background of the Invention

Typically, refrigerated container ships require the use of costly, individually refrigerated containers having a built-in refrigeration unit which requires each container have its own separate power supply, maintenance and care. Often, these refrigerated containers remain empty during a carrier's return transit from the un-load to the load port. Such empty containers take up valuable shipping space.

Various other types of refrigerated carrier ships require a separate air supply and air return ducting for each container unit. Consequently, these vessels require specialized containers which solely act as air-ducts rather than cargo crates. Moreover, these specialized containers receive conditioned air from many separate refrigeration units, thereby requiring alignment between the cargo containers and the specialized containers to facilitate air supply and return.

Other non-container vessels are also sometimes used in shipping produce. These, conventional specialized palletized refrigeration carriers have a larger refrigeration area per refrigeration unit than container carriers. However, these carriers require excessive labor for many types of cargo where the particular cargo cannot be self-stacked. For instance, this is particularly problematic with shipments of palletized produce, such as bananas. Rather, the cargo must be loaded and unloaded on each deck level not directly reached from the hatch opening, thereby requiring excessive manual labor costs and increasing port time. Moreover, such carriers have reduced utility for containerized cargo, oversized cargo, or self stacking cargo (such as forestry products). These types of specialized palletized refrigeration units also typically have separate refrigeration units for every divided floor on the vessel.

The current art in refrigerated carriers is that conditioned supply air is supplied to each tier of cargo and applies both to refrigerated containers and refrigerated pallet vessels. Each refrigerated cargo container has conditioned air being supplied to the floor at the nose of the container passing under the pallets and the air rises vertically through one level of pallets, typically two pallets wide and 10 pallets long and one pallet high. The air rises through the cargo pallets and returns in the space between the cargo top surface and the container roof and back to the refrigeration unit at the nose of the container. In this process the heat from the tail of the containers returns over the pallets in the nose of the container in its path back to the refrigeration unit. The effect is an uneven cooling of the cargo, where the pallets nearest to the nose of the container closest to the refrigeration unit see the greatest pressure differential and best cooling (as little as 5 inches of space may be above the cargo stored in containers from supply to exhaust over the top of pallets). Stored cargo pallets are secured very tightly, however, if gaps occur at unwanted locations, it can result in undesirable stagnation of air and a phenomenon known as “short cycling.” The refrigeration method in the various aforementioned refrigerated carriers can be generalized by FIG. 1. Referring to that figure, refrigerator 1 is typical of a standard refrigerated container and the airflow patterns therein. Such a refrigerator 1 has usually has a relatively small cargo 4 capacity of two (2) pallets wide by one (1) pallet high by ten (10) pallets long, wherein conditioned air 3 is cycled through the refrigerator 1 to control cargo 4 temperature. More particularly, conditioned air 3 is usually supplied at the nose 2 of the refrigerator 1. Pressure differentials drive the air 3 horizontally along the cargo 4 bottom, and vertically between the cargo 4 while forced convection transfers heat from the cargo 4 to the air 3 (or vise-versa depending on the temperature differential between the two). The air-cycle is complete after the air 3 has traversed the cargo 3 and has returned horizontally along the top of the cargo 4. Naturally, this air-cycle is detrimental to maintaining a particular cargo 4 temperature because air 3 arriving at the tail 5 bears the highest relative temperature and lowest pressure differential (which reduces the air/cargo temperature differential and air 3 velocity thereby causing heat transfer to the cargo as the relatively hot air traverses the entire horizontal length of the cargo 4 top). The effect, then, is an uneven cooling of the cargo 4 wherein the cargo 4 nearest to the nose 2 of the container 1 experiences the greatest pressure differentials and best cooling; the opposite is true for the cargo 4 nearest to the tail 5.

Inherent in current air-cycle refrigerated carriers is the phenomenon discussed above known as “short cycling.” Short cycling occurs because pressurized air follows the path of least resistance. Normally, air rises up through the cargo by way of spaces or gaps between cargo pieces (or pallets), but often, undesired gaps may exist or be formed because of poor stowage, cargo shifts and moves—changing intended flow of air and sometimes creating unwanted gaps. In this situation, conditioned air can “short cycle” and not get to cargo downstream of the undesired gap. Consequently, the associated cargo pieces become stagnate. In the most severe case, conditioned air merely travels around the outside of the entire cargo supply and returns—stagnating the entire cargo.

Yet another drawback of current air-cycle refrigerated carriers occurs when the cargo requires controlled atmosphere treatments (such as ripening, fumigation, ozone, etc.) which can potentially add significant value to the cargo with minimal costs. The risk of short-cycling prevents, or encumbers, use of the air-cycle during transport to create such controlled atmospheres. Consequently, additional costs are incurred in handling and transporting the cargo to other facilities, not to mention the cargo stress and time crunch if the goods are perishable.

### SUMMARY OF THE INVENTION

Accordingly, it is an objective of the present application to provide a cargo carrier and cargo system for refrigerated cargo that is simple and relatively inexpensive to construct. Additionally, this application seeks to provide a means for constructing a new ship with unique cargo holds or upgrading a non-refrigerated cargo carrier to a refrigerated cargo carrier in a simple and relatively inexpensive manner.

It is a further object of the present application to provide a multi-purpose cargo hold adaptable to a wide variety of uses.

It is yet a further object of the present application to provide a multi-purpose cargo carrier which is efficient in time and manpower requirements for loading and unloading. More specifically, this application seeks to provide a top-loading multipurpose cargo carrier and cargo hold.

It is a further object of the present application to provide a multi-purpose cargo hold capable of evenly conditioning the air applied to cargo beyond one tier (one loaded pallet) high. Moreover, it is the object of the present invention to provide a refrigeration method that may be capable of having reversible conditioned air-cycles (both bottom up and top down).

It is a further object of the present application to provide a multi-purpose air conditioned cargo carrier and hold capable of accommodating standard general cargo, large over-dimensioned cargos, container cargo, self-stacking break bulk cargo (such as forestry products), as well as steel or oversized cargoes that are many times the size of standard cargo containers.

It is yet another objective of this application to provide a system for moving cargo by employing a cassette, which may be collapsible.

It is a further object of the present application to provide a cargo hold that will facilitate even pressure and air flow among cargo, and that will reduce detrimental “short-cycling” in shipping.

It is a further object of the present application to provide a cargo hold and methods of shipping that eliminate the need for supply and return of conditioned air at each tier of cargo being shipped, but instead replaces such segregated horizontal air circuits with an open cargo hold that facilitates conditioned air flow through multiple tiers of cargo simultaneously. Thus, the present application supplants multiple floors, decks, or cargo levels with separate air conditioning cycles with one giant loop of reconditioned air that cycles throughout the cargo hold.

It is a further object of the present application to provide a cargo hold that may be insulated, with insulation exterior of the cargo hold.

It is a further object of the present application to provide a multi-purpose refrigerated cargo carrier and hold that minimizes the amount of empty cargo space on return transit to the original load port.

It is a further object of the present application to provide methods and apparatus for refrigerated shipping comprising adding and maintaining desired gaps between pallets during shipping. Further, the present application discloses methods and apparatus for optionally passing refrigerated air over and through a number of floors, without the requirement of returning the air to refrigeration equipment on each separate floor or tier of the vessel.

Other objectives of the invention will become apparent to those skilled in the art once the invention has been shown and described. The manner in which these objectives and other desirable characteristics can be obtained is explained in the following description and attached figures.

### BRIEF DESCRIPTION OF THE FIGURES

FIG. 1 is a generic side view of a typical prior art refrigerator 1 system using a conditioned air-cycle to cool one tier of the contained cargo 4. This particular figure was discussed above in connection with the “Background of the Invention” section.

FIG. 2A is a top view of a carrier vessel 9 of a containerized variety having a number of cargo holds 10 and top loaders 11 that are used to drop in container stored cargo.

FIG. 2B is a side plan cross-section of the carrier vessel 9 of FIG. 2A.

FIG. 2C is a front cross-section of a cargo hold 10 from the carrier vessel 9 in FIG. 2A.

FIG. 3A is a frontal cross-section of an empty refrigerated cargo hold 10 having a plurality of walls with cassette guides 23 occurring thereon, upper air ports 16, lower air ports 18, and a false floor 27.

FIG. 3B is a three-dimensional rendering of a portion of the refrigerated cargo hold 10 depicted in FIG. 3A, further showing lower air plenum 17

FIG. 3C is a top perspective of the empty refrigerated cargo hold 10 of FIGS. 3A and 3B showing suitable air port gratings 29.

FIG. 4A is a perspective view of an empty cassette 38, which is another component of an embodiment of this application.

FIG. 4B is a frontal cross-section of the cargo cassette 38 of FIG. 4A wherein the cassette 38 is being collapsed.

FIG. 4C depicts a stack of collapsed cargo cassettes 38.

FIG. 4D is a perspective view of a loaded cassette 38 for cargo.

FIG. 4E is a side view of a retractable cantilever 30 mechanism, suitably used to provide cargo separation, and as is typically used with a container flat, or deck, of this application.

FIG. 5A is a three-dimensional rendering of a portion of a multi-purpose refrigerated cargo hold 10 after it has been partially filled with a plurality of cassettes 38 loaded with palletized cargo.

FIG. 5B is a side cross-section of the refrigerated cargo hold 10 of FIG. 5A.

FIG. 5C is a top perspective of a fully loaded multipurpose refrigerated cargo hold.

FIG. 6A is a perspective view of an alternate embodiment of an empty multipurpose refrigerated cargo hold 10.

FIG. 6B is a front cross-section of the refrigerated cargo hold 10 of FIG. 6A.

FIG. 7A is a perspective view of the multipurpose refrigerated cargo hold of FIG. 6A filled with loaded cargo cassettes 38.

FIG. 7B is a front cross-section of the refrigerated cargo hold of FIG. 7A.

FIG. 8A is a pressure differential map of the refrigerated cargo hold 10 cross-section depicted in FIG. 7B.

FIG. 8B is an air-flow map of the refrigerated cargo hold 10 cross-section of FIG. 7B.

FIG. 8C is a temperature differential map of the refrigerated cross section of FIG. 7B, wherein the airflow may also be reversible to substantially eliminate a temperature gradient.

FIG. 9A is frontal cross-section of a partially filled multipurpose refrigerated cargo hold 10 of FIG. 3A, except a portion of one column of the load capacity is stacked with standard containers 47, whereas the other columns have cassettes 38 loaded with cargo.

FIG. 9B is a frontal cross-section of a fully loaded multipurpose refrigerated cargo hold 10 of FIG. 9A wherein one column of the load is loaded with stacked dry containers 47, and the remainder is loaded with filled cassettes 38.

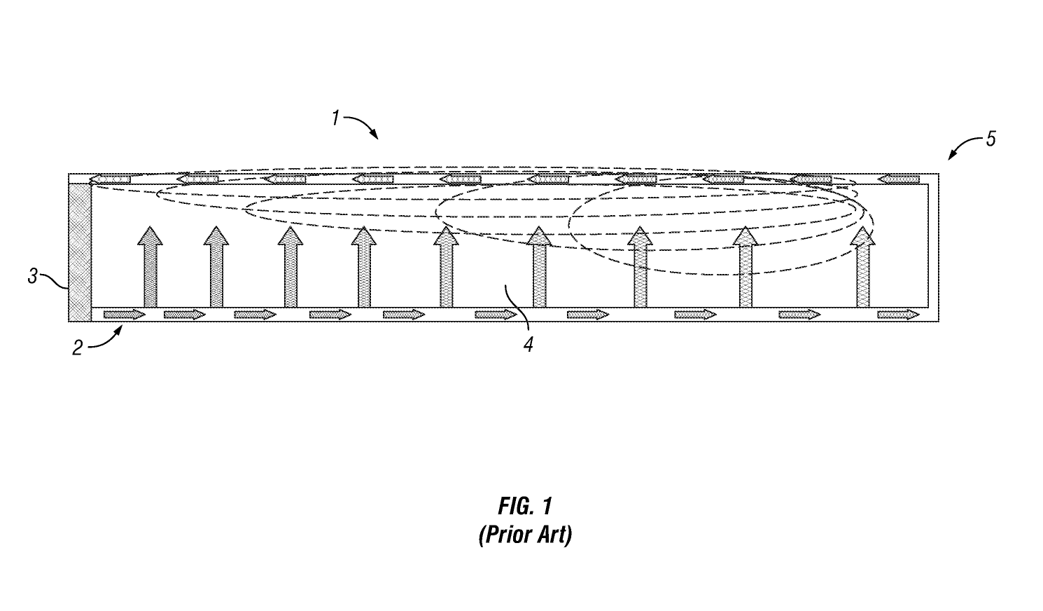

### DETAILED DESCRIPTION OF PREFERRED EMBODIMENTS

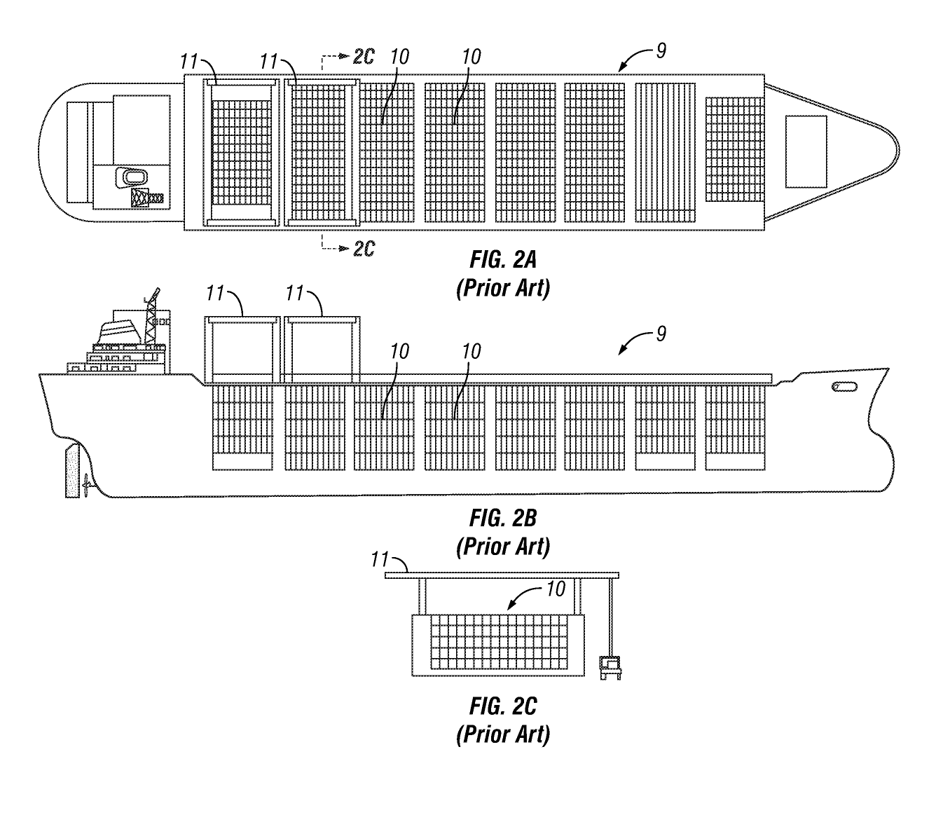

FIG. 2A is a top view of a carrier vessel 9 having a plurality of cargo holds 10 with a top loader 11 movably positionable thereover. This is a typical container ship which benefits from mechanized loading and unloading of containers. FIG. 2B is a side cross section of the same carrier vessel 9 in FIG. 2A and depicts the arrangement of typical cargo holds 10 in such a vessel and how containers, and cargo are loaded and unloaded from the top. FIG. 2C is a frontal cross section of the vessel in FIGS. 2A and 2B. These figures are presented to give context to the multipurpose cargo hold disclosed by this application.

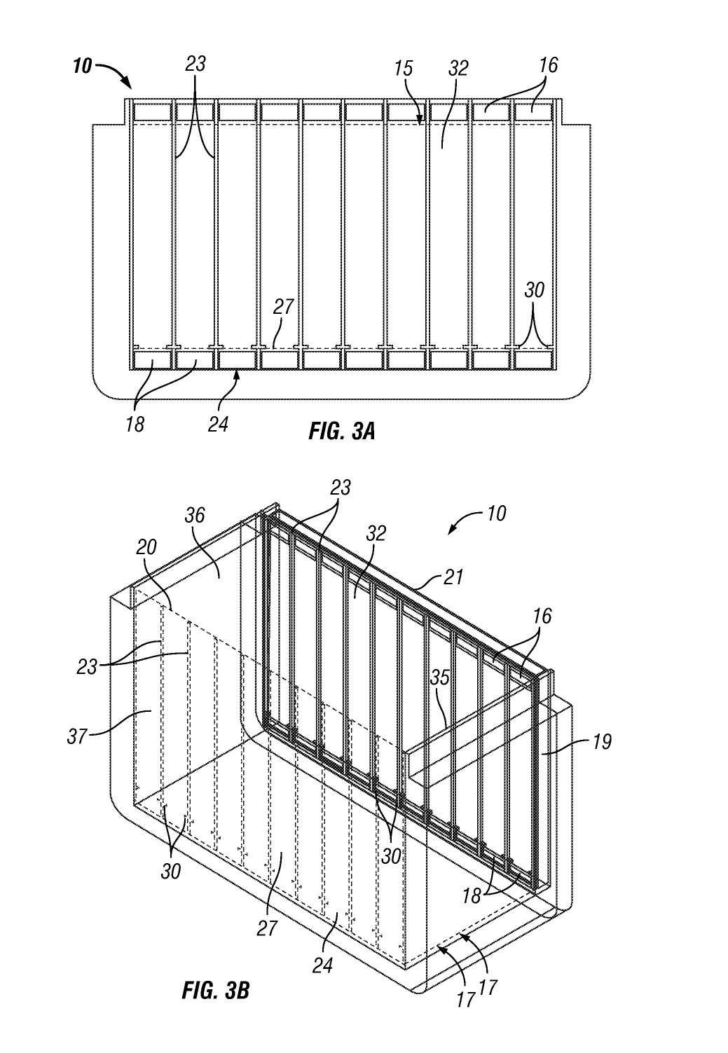

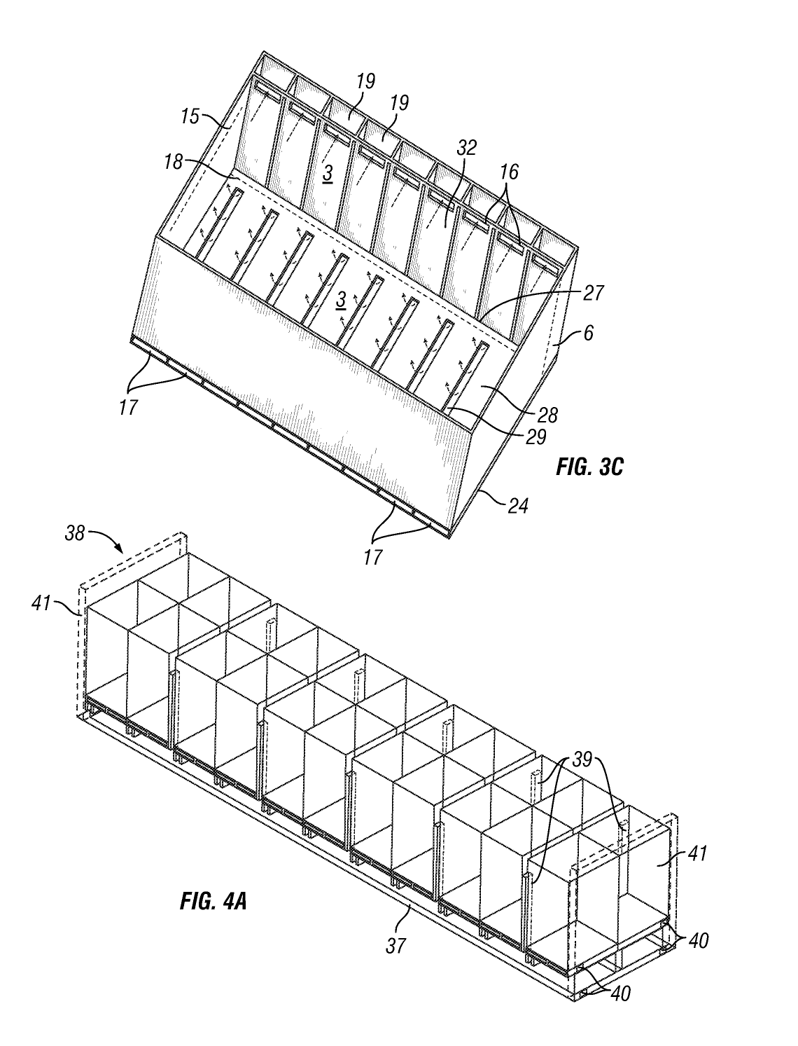

FIG. 3A is a cross-section of an empty multipurpose air conditionable cargo hold 10. FIG. 3B is a three-dimensional rendering of FIG. 3A and the two figures can be viewed in conjunction. In this particular embodiment, the multipurpose cargo hold 10 has a vertical aft-bulkhead 32 featuring a plurality of optional paired cell guides 23, a plurality of upper air ports 16, a plurality of lower air ports 18, and a plurality of retractable cantilevers 30. The aft-bulkhead 32 is positioned in front of the true aft-wall 21, thereby creating an air return duct 19 therebetween. The multipurpose cargo hold 10 essentially defines a box shape. It is suitably defined by a lid or lids, a floor, four wall sides (the fore-wall 20, the port wall 35 and starboard-walls 36, and the aft-bulkhead 32), a lower air plenum 17 (usually defined by the void space between the floor 24 and the false floor 27), and an upper air plenum 15 (FIG. 3A)(usually defined by the void space between loaded cargo 4 and a lid 25). The entire perimeter of the cargo hold 10 can be insulated, including, where practicable, the lid(s) 25 and floor 24, because the multipurpose cargo hold 10 may be refrigerated, or air conditioned. Subject thereto, the insulation may be placed on the outside of the walls to prevent insulation damage while loading cargo into the cargo hold 10. The fore-wall 37, opposite the aft-bulkhead 32, also suitably features a plurality of paired cell guides 23 and optional retractable cantilevers 30 which cooperate with the corresponding features of the aft-bulk head 32, as discussed in further detail below. Though the present embodiment is explained in terms of an aft-bulk head 32, an alternate embodiment may be explained in terms of a fore-bulk head. The cargo hold 10 is essentially a box shape, so those skilled in the art will appreciate that the cargo hold may be adapted to receive cargo loaded from the top at directions (fore/aft, or port/starboard), and where the duct-work surrounding the cargo hold (where air circulates) may be featured behind various (fore/aft, or port/starboard) walls to accomplish the air cycling described herein.

FIG. 3C is a top perspective, three-dimensional rendering of FIGS. 3A and 3B, which generally illustrates the conditioned air-cycle of the present application without loaded cargo 4. Typically, a refrigeration unit 6 is suitably situated near the air return duct 19, although other configurations are possible and the refrigeration unit 6 and accompanying blowers may be located anywhere so as to introduce air flow. The refrigeration unit 6 conditions the air 3, and disperses the air 3 through the lower air ports 18 and along the lower air plenum 17 below a false floor 27 which has been operationally configured to permit air 3 passage (in this particular embodiment, the series of false floor panels 28 feature air port gratings 29). The air 3 follows a pressure gradient up through the volume of the multi-purpose cargo hold 10 to a suitable upper air plenum 15 before the air 3 completes the cycle by entering the air return duct 19 by way of the upper air port 16 to be reconditioned by a refrigeration unit 6. The cycle may be reversed so that the conditioned air 3 is dispersed in reverse direction along the upper air plenum 15 and forced down along a pressure gradient through the volume of the cargo hold 10 to the lower air plenum 17 below the false floor 27. In other words, the cargo hold 10 permits flow of air top-to-bottom, or bottom-to-top throughout the cargo hold 10, which facilitates even and temperature throughout the cargo hold 10. Alternating reversible cycles are also contemplated. While the refrigeration unit 6 is typically placed in or near the return air duct 19 in the present embodiment, in an alternate embodiment, the refrigeration unit 6, and blowers, could be placed anywhere to facilitate the air-cycle. Subject thereto, the refrigeration unit 6 should usually be placed outside the multi-purpose cargo hold 10 to avoid inadvertent damage to the refrigeration unit 6 while loading cargo 4. The construction of the false floor plenum, air ducting, refrigeration units, and blowers may be removable modular units.

FIG. 3C depicts a false floor defined by false floor panels 28 featuring air port gratings 29, however, as discussed further below, a false floor 27 may simply be defined by the lower end of loaded cargo 4 suspended above the actual floor 24.

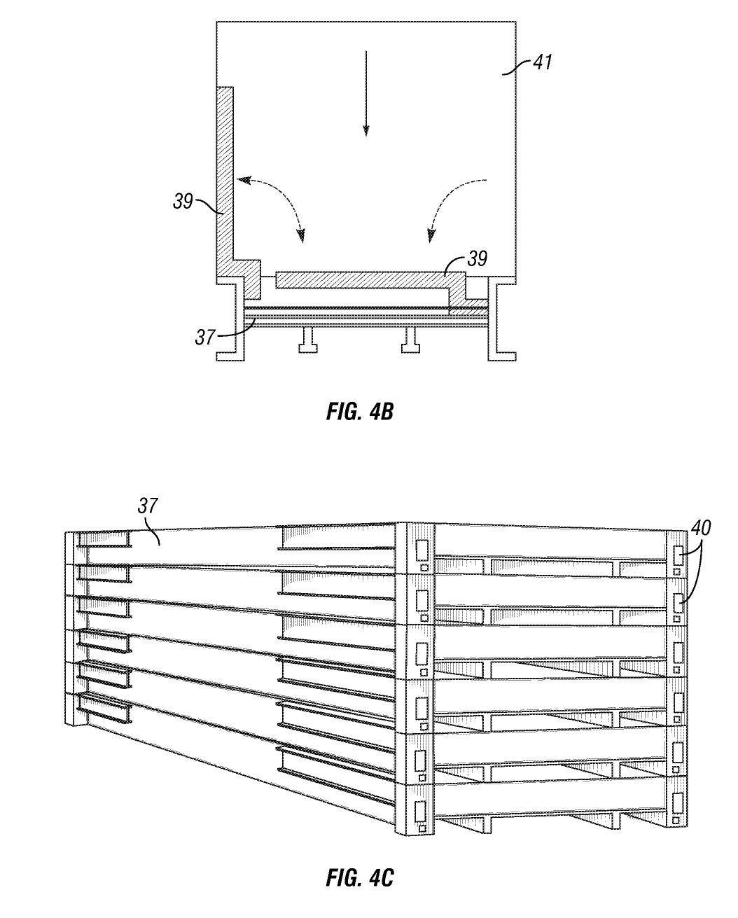

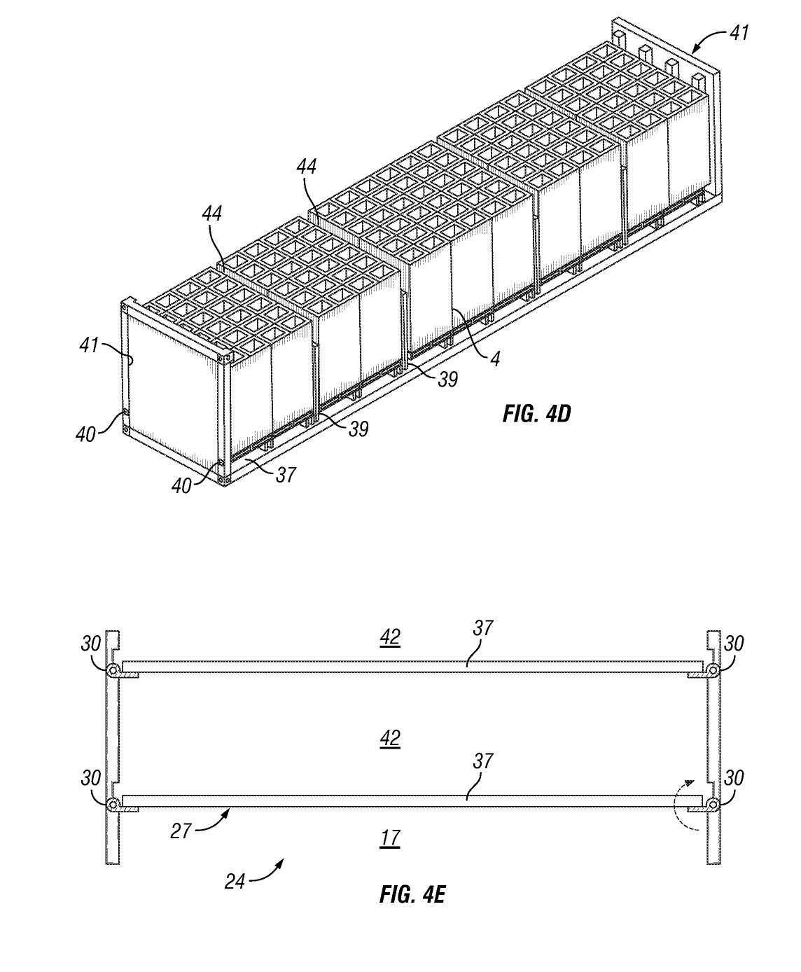

FIG. 4A depicts a cross-section of a typical loaded cassette 38. A cassette 38 is operationally configured to be top-loaded into a multipurpose cargo hold 10, and is useful as part of a system for improved cargo loading. The cargo cassette 38 is defined by a base 37, which features connectors 40, and which cassette 38 may be operationally configured to permit some air 3 passage. The cassette 38 further features a plurality of optional collapsible stanchions 39 extending periodically along the length of the base; and collapsible ends 41. In some embodiments, it may be desirable for the collapsible stanchions 39 to be extendable to increase the height of the cassettes 38 or to accommodate taller cargo 4 shipments. These collapsible stanchions 39 may be rotatably, fixedly, or removably connected to the cassette 38. An erect cassette 38 may be identified by the stanchions 39 and ends 41 extending perpendicular to the base 37. To accomplish cargo hold 10 loading, a cassette 38, (whose length is sufficient to suspend between the aft-bulkhead 32 and the fore wall 20) is suitably lowered from above the multi-purpose cargo hold 10, until connectors 40 on the base 37 of the cassette 38 associate with the corresponding pairs of cell guides 23 on the aft-bulkhead 32 and the fore wall 20. The cassette 38 is further lowered along the cell guides 23, where they may stack on other cassettes 38, or on a floor, or false floor. A variety of loading means may be used in connection with the cargo hold 10 of the present application. In addition to cassettes, loading means may include container flats, also known as “decks,” which may also be lowered along the cell guides 23, where they may optionally be secured by retractable cantilevers 30. Cassettes 38 or alternately loading means such as flats are lowered along the cell guides 23 until they rest on the retractable cantilevers 30, the false floor panels 28, or a previously loaded cassette 38. As mentioned previously, cell guides 23 may be located on any of the walls of cargo hold 10.

FIG. 4B is a cross-section of one embodiment of an empty collapsible cassette 38 and it illustrates how an erect cassette 38 may be collapsed. The stanchions 39 and ends 41 may fold, and suitably within, near, or along a base 37. A collapsed cassette 38 resembles a base 37, or flat, with no perpendicular extensions. Materials used in the construction of the cassette base 37 must be sufficient to bear a cargo load while suspending over a void. Such materials will be apparent to one skilled in the art.

Collapsed cassettes 38 may be stacked together to consolidate inventory. As FIG. 4C illustrates, six stacked collapsed cassettes 38 result in approximately the same physical dimensions as a single erect cassette 38. Accordingly, stacking collapsed cassettes 38 will free up cargo space when cassettes 38 are not in use, without disrupting the vertical or horizontal cassette 38 load patterns. Also, containers flats or decks may be similarly stacked or stored to free up room on a ship when not in use.

FIG. 4D depicts an erect cassette 38 loaded with cargo 4. In the prior art refrigeration deck of a specialized refrigerated cargo carrier, the cargo has to be manually loaded using individual pallets. While loading the multipurpose cargo hold 10 of the present application, such a cassette 38 (or a flat) may be loaded with a number of cargo 4 pallets which can be subsequently loaded into the refrigerated cargo hold 10 at once. Moreover, the cassette 38 is a desirable optional feature to be used with the multipurpose cargo hold 10, because the cassette 38 is suitably designed to facilitate a consistent vertical pressure gradient while also allowing conditioned air 3 to circulate around the cargo 4. The base 37 is configured to permit some air 3 passage, and the stanchions 39 hold the cargo in position while at the same time introducing air gaps 44 throughout the cargo 4. By holding the cargo 4 in position, the stanchions 39 forestall the shifting of cargo 4 during shipment and the associated “short-cycle” phenomena discussed above. By creating air gaps 44 throughout the cargo 4, air 3 circulation is facilitated in a regulated manner within the cargo 4. This arrangement allows for the greater movement of volumes of air to remove heat, and a substantially even vertical pressure differential can be sustained along a cassette 38. An additional function of the cassette 38 is that, before loading or after unloading, the cassettes 38 may act to hold cargo as interim transit racking for the cargo—essentially a mobile warehouse for the produce that prevents the need to store in refrigerated warehouses. Another noteworthy feature of the stanchions 39 is that in addition to helping to maintain vertical pressure and airflow throughout the cargo hold, they also facilitate treatment and exposure of the cargo with preservative air treatments, such as ozone.

FIG. 4E is a crude longitudinal cross-section of a single cell guide 23 which has been vertically loaded with two loading means 42. This figure more fully depicts how multiple loading means 42, shown here as flats, might be loaded into a multipurpose cargo hold 10 using retractable cantilevers 30. A first top loaded loading means 42 lowers along a cell guide 23 passing closed cantilevers 30 until its vertical load position is dictated by corresponding and open cantilevers 30. A second top loading means 42 follows the same procedure until it is vertically situated above the first, whereafter the second may rest on top of the first, or may be situated on another set of corresponding cantilevers 30, as depicted by FIG. 4E. To some extent, then, a set of corresponding retractable cantilevers 30 act as a footing for a loading means 42 as it suspends across the cargo hold 10. Open cantilevers obstructing the cassette 38 guide must be closed while the cassette 38 is moving up or down along the cell guides 23 to allow passage. Applicant contemplates that the corresponding pairs of cell guides 23, be configured to receive standard ISO shipping containers. Accordingly, the loading means 42 are usually configured to those dimensions. However, applicant also contemplates a multipurpose cargo hold 10 wherein the corresponding pairs of cell guides 23 are configured as necessary to accommodate various dimensioned cargo—loading means 42, including cassettes 38, flats, or other. The cell guides 23 and retractable cantilevers 30 therefore serve to guide stacking and securing of top loaded cargo. It should be noted that loading means 42 as used herein may be from any of the group consisting essentially of either cassettes, flatracks, platforms, decks, traveling boards, cages, bins, or tubs.

FIG. 4E also illustrates how the lowest set of corresponding cantilevers 30 may be used to define a false floor 27. As depicted in this figure, the cassette 38 suspends across the cargo hold 10 creating a void between the actual floor 24, and the loading means 42. This void may, in turn, define the lower air plenum 17.

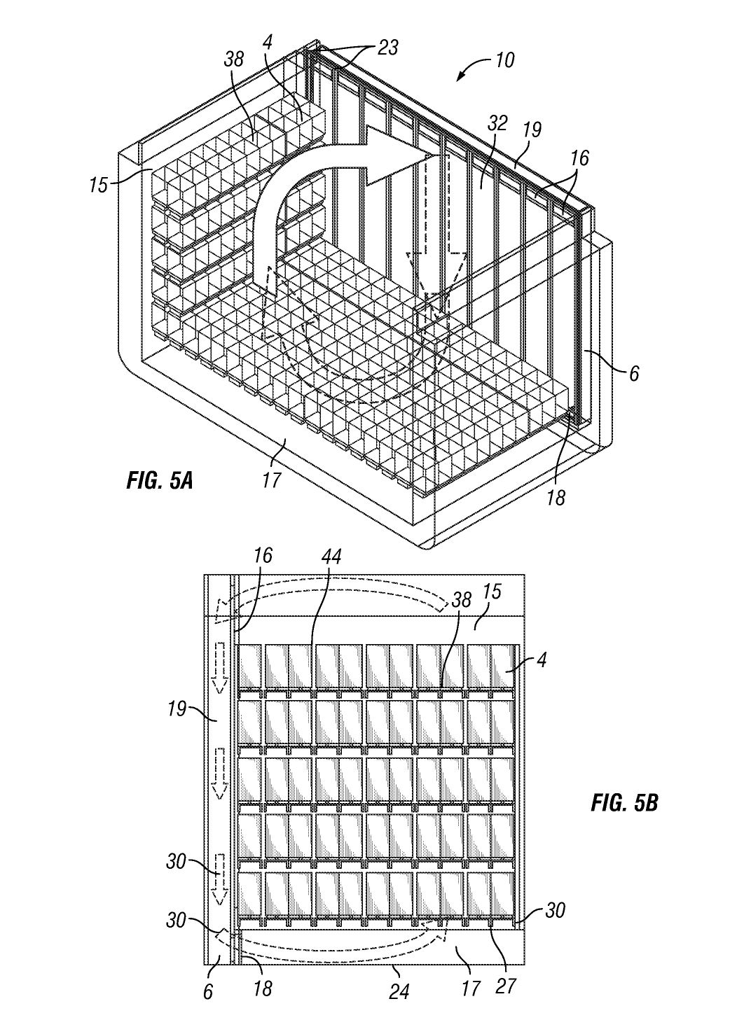

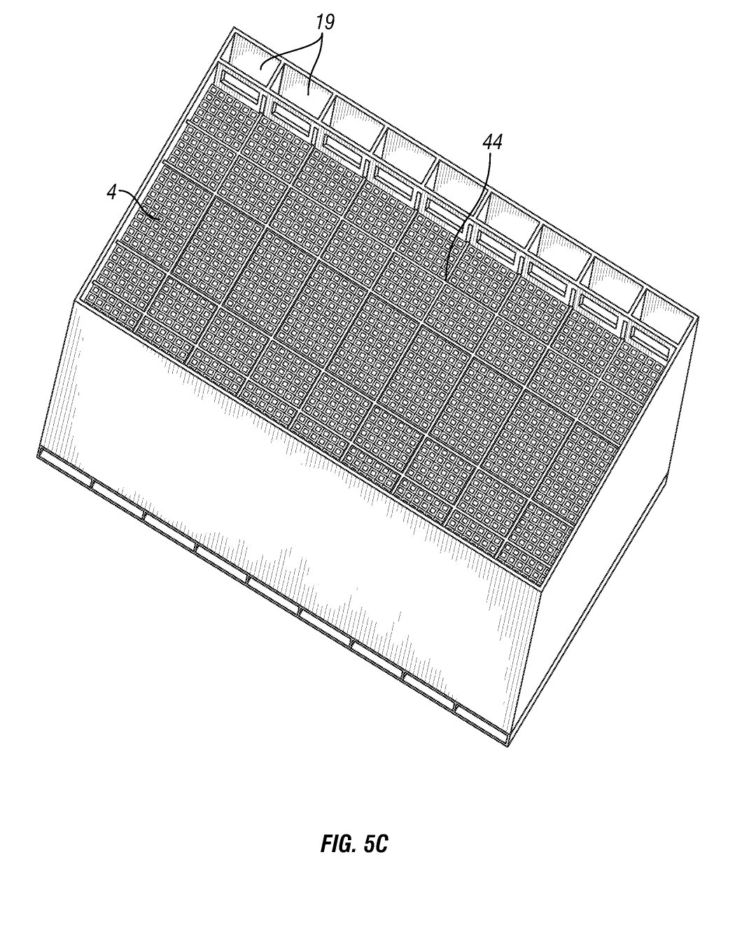

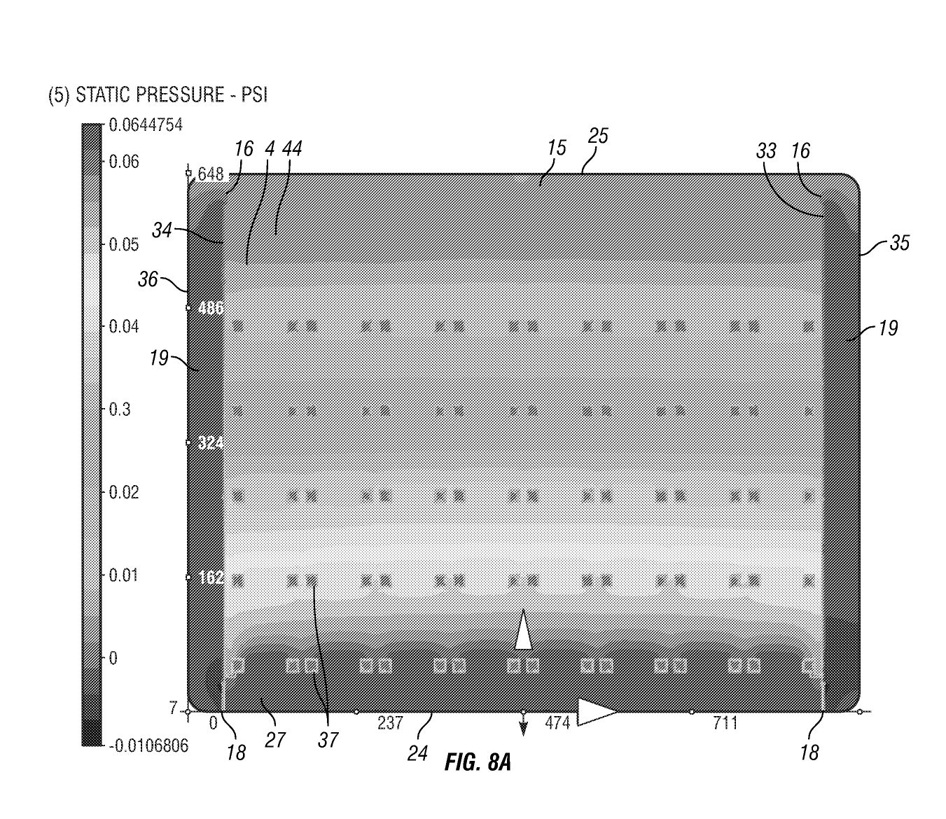

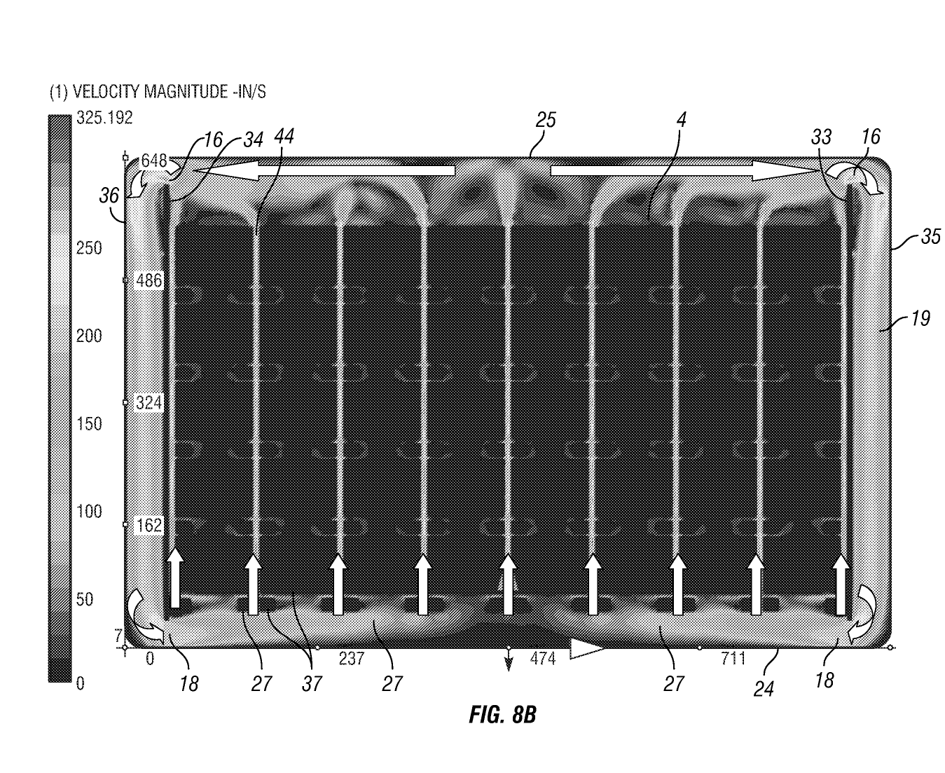

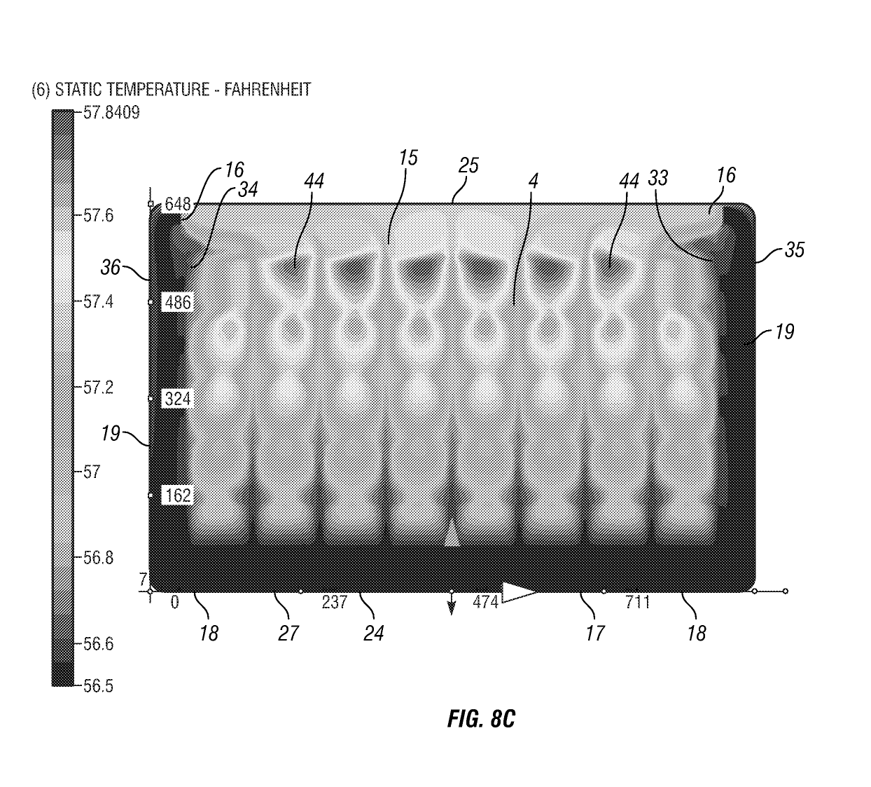

FIG. 5A illustrates a multipurpose refrigerated cargo hold 10 which has been partially loaded with a series of loading means 42 in the form of cassettes 38 filled with cargo 4. Also, this figure more completely illustrates the cassette 38 top loading process. Cassettes 38 are loaded and guided into the cargo hold 10 according to corresponding pairs of cell guides 23. The vertical cassette 38 load pattern is dictated by either the resting successive cassettes 38 directly on top of the lower cassette 38, or sometimes through the use of retractable cantilevers 30, to positions on the successive cassettes 38 above the lower cassettes 38. FIG. 5A is also beneficial in that it demonstrates cycled air flow throughout the cargo hold 10, as opposed over separate horizontal tiers of cargo, with refrigeration and blower units located on each horizontal floors. Air is circulated not just over and through one tier of cargo 4, but instead through multiple tiers. This particular FIG. 5A demonstrates how air may be circulated through five separate tiers of cargo, although more or fewer tiers are also contemplated. Because of the flow pattern of the conditioned air in the cargo hold 10, “short cycling” risks are reduced and cargo is better maintained and preserved. This is in part because there is greater distance between supply and return air in the cargo holds 10 of the present application. The air plenums for supply and return air are supplied with a greater distance. Typically, for example, four or five tiers of palletized cargo may separate the air supply and returns—as opposed to a single tier of cargo (usually a floor to ceiling height of 8 foot) as in the prior art. In addition, a greater volume of air flow, and organized air gaps, permit a more regulated and effective cycling of air and pressure to condition the cargo being transported. This is further shown in FIGS. 8A-8B.

FIG. 5B is a side cross-section of a cassette 38 loaded cargo hold 10 depicted in FIG. 5A. FIG. 5C is a top perspective of a cassette 38 filled multipurpose refrigerated cargo hold 10. FIGS. 5A, 5B, and 5C illustrate the conditioned air-cycle for a full cargo hold 10 and they may be viewed in conjunction with one another. In this non-limiting example, a lower air plenum 17 is created when the lowermost cassettes 38, in each set of cell guides 23 suspends across the cargo hold 10 as depicted in FIGS. 5A and 5B. An upper air plenum 15 is created when the upper most cassettes 38, in each set of cell guides 23 suspends across the cargo hold 10 as depicted by FIGS. 5B and 5C. If the contained cargo 4 reaches the top of the cargo hold 10, the lid (s) may be hollowed out to create the void(s) necessary to produce an upper air plenum 15. Beginning with FIGS. 5A and 5B, the refrigerator unit 6 conditions air 3 in the air return duct 19 and disperses the conditioned air 3 through the lower air port 18 and throughout the lower air plenum 17 along the false floor 27. A vertical pressure differential drives the air 3 through the cassettes 38 and cargo 4. The vertical pressure differential is suitably substantially consistent at each successive cargo 4 tier because the stanchions 39 substantially diminish cargo 4 shifting (to avoid air 3 short-cycle) and create air gaps 44 consistent in width and pattern throughout each tier. Forced convection occurs at each cargo 4 tier as the air 3 moves toward the upper air plenum 15, aided by turbulent and air interchange across packaging vents. Referring to FIGS. 5B and 5C, the conditioned air-cycle is complete when the air 3 in the upper air plenum 15 passes through the upper air port 16 to be reconditioned in the return air duct 19. It should be noted that the direction of air flow can be reversed. Air can be moved through cargo 4 from top-to-bottom and vice-versa, or alternately from starboard to port or port to starboard.

As mentioned above, forced convection transfers heat from the cargo 4 to the conditioned air 3 (or vise-versa) via a temperature gradient between the two. Accordingly, the air 3 temperature increases as it moves through successive cargo 4 tiers toward the upper air plenum 15. Were the conditioned air-cycle non-reversible, the realities of heat transfer would result in the lower tiers of cargo 4 maintaining a somewhat lower temperature relative to the upper tiers. Reversing the air-cycle so that the refrigerator unit 6 disperses the conditioned air 3 through the upper air port 16 and throughout the upper air plenum 15, forces the air 3 down through the cargo 4 (having reverse consequences of those described above), and allows the entire cargo 4 temperature to balance.

The ability to ensure practically consistent pressure differentials across each cargo 4 tier, the ability to diminish (practically avoid short-cycling) and the ability to reverse the conditioned air-cycle provided by the multipurpose cargo hold 10 is also ideal for cargo 4 which may require controlled atmosphere treatments (such as ripening, fumigation, ozone, etc.) because such a cargo hold 10 produces an equal dose of treatment throughout the entire cargo hold 10 when such treatments are introduced into the air-cycle. Moreover, in a cargo hold 10 of the present application, controlled atmospheric treatments may be introduced into the conditioned air-cycle during transport, thereby avoiding the need to move the cargo 4 to a separate facility or treatment while the vessel 9 is docked.

Though the particular embodiment depicted in FIGS. 3A through 5C represented a multipurpose refrigerated cargo hold 10 having the air return duct 19 and the refrigeration unit 6 in the aft of the cargo hold 10 behind the aft-bulkhead 32, similar results may be achieved whether the bulkhead 32 (and the associated upper 16 and lower 18 air ports) are in the aft, fore, port, or starboard sides with the air return duct 19 and refrigeration unit 6 therebehind. Also, FIGS. 3A through 5C depicted a cargo hold 10 wherein cassettes 38 are top loaded to span the cargo hold 10 in an aft/fore relationship, but, the multipurpose cargo hold 10 of the present invention can be adapted to a cargo hold 10 wherein the cassettes 38 are top loaded in an port/starboard relationship.

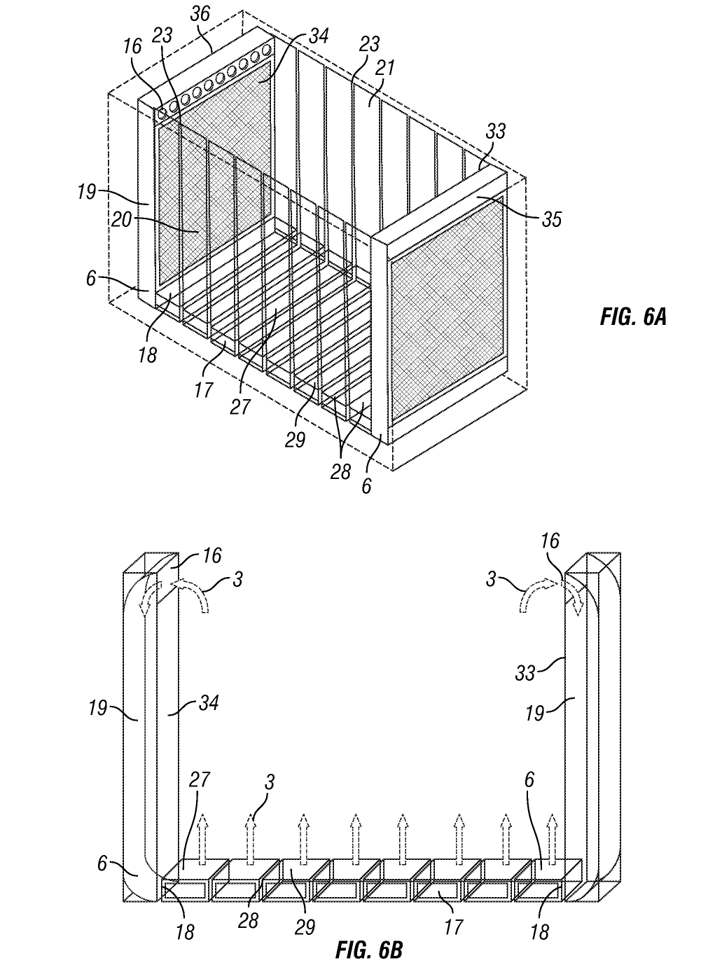

As will be appreciated by those skilled in the arts, the multipurpose cargo hold 10 can manifest in a variety of embodiments. FIGS. 6A through 8C depict a particular variation of the multipurpose cargo hold 10 of the present applications wherein a return air duct 19 and refrigeration unit 6 are installed on opposing sides of the cargo hold 10. It should be noted that in alternate embodiments of the present application, supply and return air, and corresponding plenums can be located anywhere throughout the cargo hold and used to deliver and return air from a variety of directions. For instance, air supply could originate from the port side, with air return on the starboard side; or alternately with air supply originated from either the fore and aft. The principal concern is that air remains in fluid communication despite the chosen locations of supply and return vents.

FIG. 6A is a three-dimensional rendering of an alternate embodiment of an empty multipurpose cargo hold 10. This particular cargo hold 10 has a vertical port-bulkhead 33 and an opposing vertical starboard-bulkhead 34, each bulkhead featuring its own respective upper 16 and lower 18 air ports. Adjacent to the bulkheads (33 and 34) are the fore wall 20 and aft wall 21 featuring corresponding pairs of cell guides 23. Once again, the entire perimeter of the cargo hold 10 may be insulated, including, where practicable, lid(s) 25 and a floor 24, because the multipurpose cargo hold 10 is typically refrigerated. Subject thereto, insulation may be placed on exterior cargo hold walls to prevent damage to the insulation during cargo loading. A first air return duct 19 and a first refrigeration unit 6 are suitably located between the port bulkhead 33 and the port wall 35. A second air return duct 19 and a second refrigeration unit are located between the starboard bulkhead 34 and starboard wall 36. A series of false floor panels 28 (featuring air port gratings 29) run long the floor 24 to produce a false floor 27. A lower air plenum 17 is defined by the void between the false floor 27 and the floor 24.

FIG. 6B is a frontal cross-section of the empty multipurpose cargo hold 10 of FIG. 6A. FIG. 6B illustrates the conditioned air-cycle for an empty cargo hold 10. First, the refrigeration units 6 condition air in respective return air ducts 19 and opposingly disperse the conditioned air 3 through respective lower air ducts 18 and throughout the lower air plenum 17. Second, a vertical pressure gradient drives the air 3 upwards through the false floor 27 by way of the air port gratings 29 in the false floor panels 28. Air 3 rises through the cargo hold 10 to an upper air plenum 15 (not shown). Finally, the air-cycle is completed after the air 3 passes through the upper air ports 16 and into the return air duct 19 on either the port 33 or starboard side 34. The air-cycle could be reversed, with the conditioned air 3 being dispersed through the upper air port 16 and throughout an upper air plenum 15, forced down through the false floor 27, and back through the lower air ports 18.

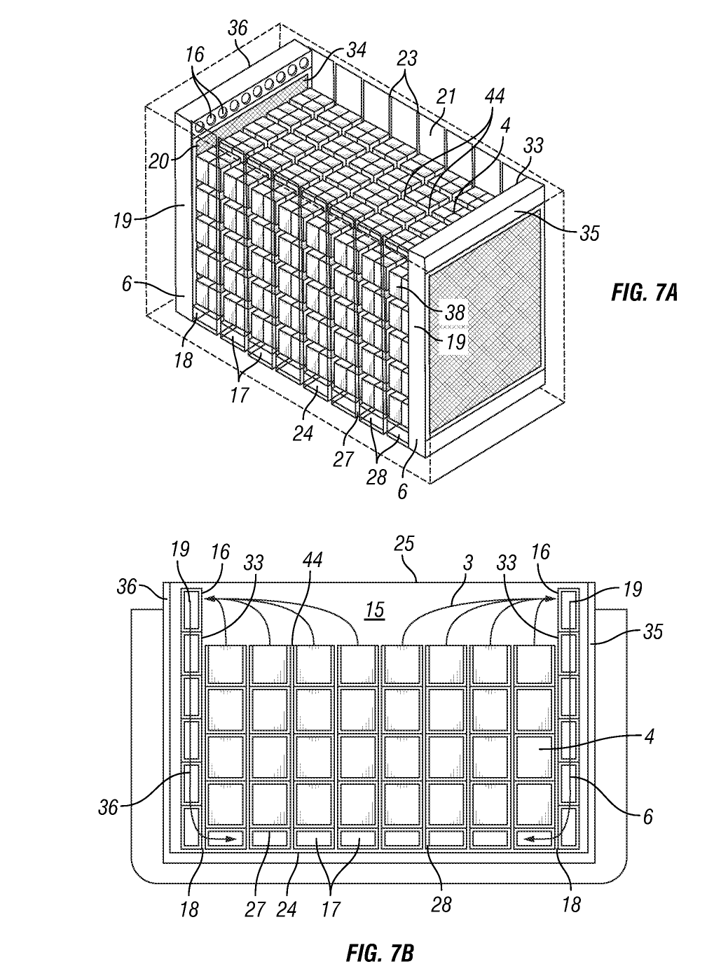

FIG. 7A is a three-dimensional rendering of a cargo hold 10 fully loaded with cassettes 38. Cassettes 38 are top loaded, as discussed above, using interaction between the connectors 40 and the cell guides 23. In this particular embodiment, the lowermost cassettes 38 are stacked on top of the false floor panels 28, with the vertical load pattern dictated by the height of the loaded cassettes 38 (in an alternate embodiment, retractable cantilevers 30 could be used to define the false floor 27 the vertical cassette 38 load pattern). Once again, the cassette 38 load pattern is optionally dictated by the corresponding pairs of cell guides 23. An upper air plenum 15 is defined by the top of the uppermost cassette 38 and the cargo hold lid 25. The cassettes 38 used in this embodiment are loaded with cargo and include the same features (stanchion 39 and ends 41) as discussed in connection with the previous embodiment. Ends 41 may also be collapsible.

FIG. 7B is a frontal cross-section of the multipurpose refrigerated cargo hold 10 of FIG. 7A. FIGS. 7A and 7B illustrate the conditioned air-cycle for this particular embodiment of a fully loaded multipurpose cargo hold 10. Both refrigeration units 6 condition air 3 in their respective air return ducts 19 and opposingly disperse the conditioned air 3 through the respective lower air ports 18 and throughout the lower air plenum 17. A vertical pressure differential drives the air 3 across the false floor 27 and up through the cargo 4. A substantially even pressure differential exists along the false floor and at each cargo tier, in part, because the extended stanchions 39 prevent the cargo 4 from shifting and provide even spacing and a consistent pattern for the air gaps 44 at each tier and throughout the entire cargo 4. As air 3 rises through the cargo 4, any temperature differential between the air 3 and cargo 4 drives forced convention heat transfer from the cargo 4 to the air 3 (or, vice-versa). After the air 3 has passed through the cargo 4, the air 3 collects at the upper air plenum 15 before it completes the cycle by entering the upper air port 16 to the return air duct 19 for re-conditioning.

As with the first embodiment of the multipurpose refrigerated cargo hold 10 disclosed in this application, in FIGS. 7A-7B, the air 3 will typically increase in temperature as it rises through the cargo 4. In a non-reversible conditioned air-cycle, the lower cargo 4 tiers would maintain a lower temperature relative to the upper tiers. However, in a reversible conditioned air-cycle, an approximately even temperature may be maintained throughout the cargo hold 10.

Also, similar to the previously disclosed embodiment, this alternative embodiment of the multipurpose refrigerated cargo hold 10 is ideal for shipping cargo 4 requiring controlled atmospheric treatments. Once again, the ability to produce substantially even pressure differentials at each tier, avoid air “short cycles,” and reverse the air cycle produces a substantially consistent atmosphere throughout the entire cargo hold 10 and provides a substantially even dose of treatment to all cargo 4 when such treatment is introduced into the conditioned air-cycle.

FIG. 8A is grey scale pressure distribution inside the depiction of FIG. 7B. Darker portions depict higher pressure. FIG. 8A illustrates one advantage of the multipurpose cargo hold 10 of the present application and provides a visual of the phenomenon described above. Generally, FIG. 8A depicts a substantially consistent vertical pressure gradient from the false floor 27 to the cargo 4 top, and a substantially even pressure horizontally throughout each cargo 4 tier. This consistent vertical and horizontal pressure behavior is partially a result of the stanchions 39 which practically prevent the cargo 4 from shifting (which would thereby disrupt the pressure distribution) and effect a consistent width and pattern for the air gaps 44. More particularly, the consistent width and pattern of the air gaps 44, and spacing of air gaps near the cell guides 23 play a significant role in providing the substantially even horizontal pressure distribution.

FIG. 8B is a grey scale air-velocity map of FIG. 7B. Lighter shades depict faster air 3 velocity. FIG. 8B illustrates the practical result of a pressure distribution depicted by FIG. 8A. Air 3 travels the pressure gradient along the paths of least resistance. In part, because of the air gaps 44, air has roughly equivalent velocities as it rises through the cargo 4, and is evenly distributed throughout the cargo 4. Roughly equivalent velocities through the cargo 4 are particularly important for controlled atmospheric treatments. If the air 3 is moving throughout the cargo 4 at roughly the same velocity, the consequence is that all cargo 4 is substantially equally exposed to treatments introduced into the air-cycle.

FIG. 8C is a grey scale temperature map of FIG. 7B. Lighter shades equal higher temperatures. Because of the relatively even air 3 flow throughout the cargo 4, air 3 and cargo 4 temperatures remain substantially horizontally even, but (as mentioned above) vertically increasing. The relatively even horizontal temperatures allow a substantially constant temperature to be maintained through reversing the cycle whereby higher air temperatures are achieved at the lower portion of the cargo. In other words, the act of alternating the conditioned air cycle can balance temperatures so they are substantially consistent throughout the entire cargo 4.

Even though FIGS. 6A through 8C depict a multipurpose cargo hold 10 having opposing vertical bulkheads (with associated components) on the starboard and port sides, a different variation might have the vertical bulkheads (and associated components) on the fore and aft sides. An analogous statement can be said about the cell guides 23 and the orientation of vertically loaded cassettes 38.

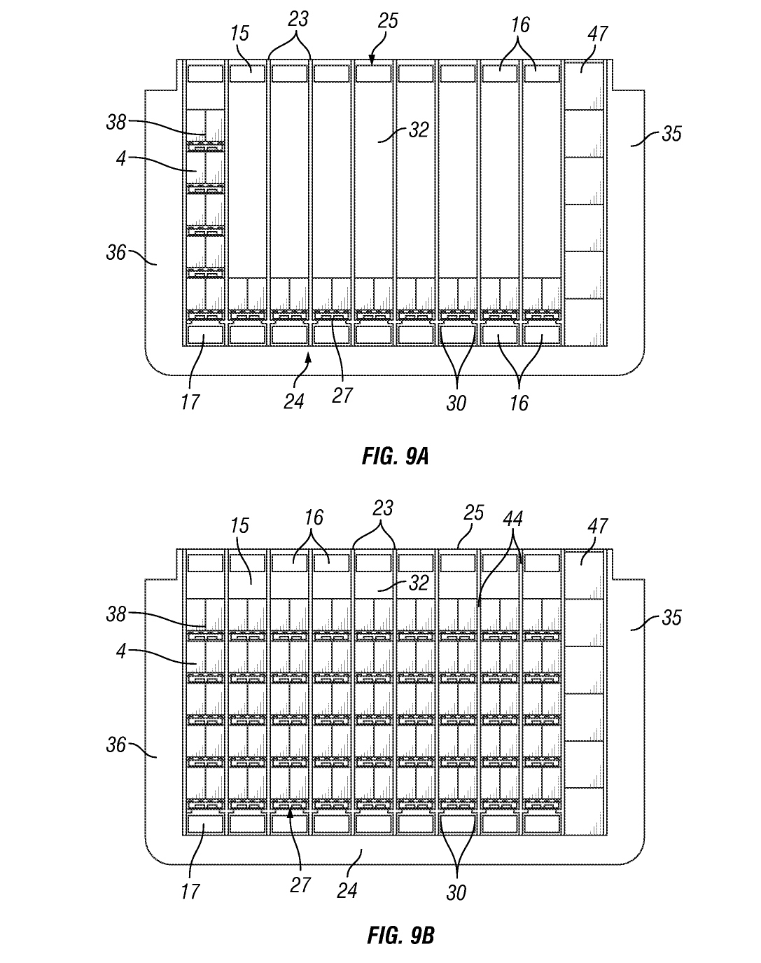

Another advantage of the multipurpose cargo hold 10 of the present application is the ability to ship perishable goods (goods which need refrigeration) in the same cargo hold 10 as dry goods (goods which do not need refrigeration). This feature is important, for example, where a perishable order is insufficient to fill a refrigerated cargo hold 10; normally, such shipments are made inefficiently with the cargo hold 10 partially empty (resulting in a monetary loss to the carrier), or the cargo 4 is shipped at a higher price (resulting in a monetary loss to the shipper). A particular advantage of the multipurpose cargo hold 10 of the present application is that the dry goods containers 47 and the cassettes 38 can both be top loaded using the cell guides 23. In other words, there is no change in loading philosophy between the types of shipments in the cargo hold 10. Accordingly, FIG. 9A illustrates the aspect of the multipurpose cargo hold wherein perishable shipments may be shipped in the same cargo hold 10 as dry goods without changing the loading philosophy or loading method for the different types of goods being shipped.

FIG. 9A is a frontal cross-section of a partially loaded multipurpose cargo hold 10 depicted by FIGS. 3A through 3C and 5A through 5C. The aft-bulkhead 32, the upper 16 and lower 18 air ports, and the cell guides 23 can be seen in the rear. Since the cell guides 23 are configured to accept standard ISO shipping containers, the cassettes 38 have been top loaded on the starboard side 36 and a single column of dry containers 47 have been top loaded on the port side 35 using the same loading method. Though only a single column is occupied by dry containers 47, dry goods containers could fill a majority, if not all, of the multipurpose cargo hold 10.

Though both the cassettes 38 and the dry containers 47 are both top loaded using cell guides 23, the lowest cassette 38 in a given column rests on the lowest open retractable cantilever 30 to produce a false floor 27 while the dry container rests on the floor 24. Also, the top of the highest cassette 38 in a given column defines the lower boundary of the upper air plenum 15 while the highest dry container 47 nearly meets the lid 25 of the multipurpose cargo hold 10.

FIG. 9B is a fully loaded multipurpose cargo hold 10 of FIG. 9A. The conditioned air-cycle may be implemented in the tiers of cargo 4 loaded with cassettes 38 in the same manner described above. Since the cassettes 38 are configured to facilitate air 3 flow (because of the base 37, and the stanchions 39), and because the dry containers 47 do not facilitate air flow, conditioned air 3 basically circulates through the cassettes 38 only because air follows the path of least resistance (i.e., the air gaps 44). What little effect, if any at all, the conditioned air cycle has on the dry containers 47, would be innocuous. Also, a vertical bulk head may be positioned between the columns of dry containers 47 and cassettes 38 to further isolate the dry containers from refrigerated air. In fact, vertical bulkheads may divide up a particular multipurpose refrigerated cargo hold into various temperature controlled sections.

Applicant discloses a shipping vessel 9, which may be of any variety of shipping vessel, being fabricated having cargo holds 10 of the type disclosed by the present application, pre-installed therein. Also, Applicant further discloses that a normal carrier vessel 9, having at least one top loading cargo hold, may have its cargo holds upgraded or retrofitted to the type disclosed by the present application. The shipping vessel 9 can be configured to carry a variety of cargo, including containers, refrigerated cassettes, and/or break bulk (self-stacking) cargo.

An ordinary cargo hold may be upgraded to a multipurpose cargo hold 10 depicted in FIGS. 3A through 5C as generally follows: (1) erect a bulkhead (having an upper air port 16 and a lower air port 18) at one end of a cargo hold and establish a return air duct 19 therebehind; (2) if the bulkhead replaced a cargo hold wall having a plurality of cell guides 23, then the bulkhead should have cell guides installed which correspond to the cell guides 23 on the opposite wall (typically standard ISO compatible) and the bulkhead should be positioned relative to the opposing wall to accommodate top loading of cassettes 38, or else go to optional step (3), which is (3) insulate the entire perimeter of the cargo hold, including, where practicable, the lid 25 and floor 24; (4) install a refrigeration unit 6 and blowers (which may be reversible) in the return air duct 19; and, (5) optionally install a series of false floor panels 28 having air port gratings 29 along the insulated floor 24.

An ordinary cargo hold may be upgraded to a multipurpose cargo hold 10 depicted in FIGS. 6A through 8C generally as follows: (1) erect opposing bulkheads ( each having an upper air port 16 and a lower air port 18) at two sides of a cargo hold 10 and establish a return air duct 19 behind each one; (2) if the bulkheads replaced a cargo hold wall having a plurality of paired cell guides 23, then the bulkheads should have corresponding cell guides 23 installed (typically standard ISO compatible) and the bulkheads should be positioned relative to each other to accommodate top loading of cassettes 38, or else go to optional step (3); which is to insulate the entire perimeter of the cargo hold, including, where practicable, the lid 25 and floor 24; (4) install a refrigeration unit 6 and blowers (optionally reversible) in each return air duct 19; and, (5) optionally install a series of false floor panels 28 having air port gratings 29 along the insulated floor 24.

Though the discussion regarding the upgrade of an ordinary cargo hold contemplated using a series of false floor panels 28, installing retractable cantilevers instead would also accomplish the desired upgrade. Moreover, the upgrades discussed above, need not be permanent.

Disclosed are a method for shipping and conditioning air surrounding cargo 4 on a carrier vessel comprising the steps of: loading cargo 4 onto a loading means; forming a plurality of air gaps throughout the cargo in the cargo hold 10; placing supply and return air plenums in fluid communication with one another; delivering and circulating conditioned air to all of said cargo via an air conditioning means. Further disclosed is the optional step of loading cargo 4 between said supply and return air plenums. Further disclosed is the optional step of delivering and circulating conditioned air to all of said cargo through said air gaps throughout the cargo 4 in the cargo hold 10. Further disclosed is the optional step of circulating conditioned air through a plurality of tiers of cargo 4 located in the same cargo hold 10. Further disclosed is the optional step of circulating conditioned air through at least two tiers of cargo 4. It is disclosed that cargo 4 could be palletized bananas, or alternately be from the any of the group of produce consisting of either melons, avocadoes, fish, citrus, stone fruit, grapes, vegetables, meat, or poultry. Disclosed is a loading means, which may be configured to allow the passage of conditioned air, which loading means may be from any of the group of items known as either cassettes, flatracks, platforms, decks, traveling boards, cages, bins, or tubs. A cassette may have collapsible ends. Further disclosed is a method where air gaps 44 are formed by use of stanchions 39 fixed to said loading means to secure cargo and define air gaps through said cargo. Loading means may be loaded by using cell guides on walls of the cargo hold. Disclosed is a cargo hold 10 comprising: at least one space defined by a floor, a plurality of walls, and at least one openable lid wherein a least two of said walls oppose one another and wherein said cargo hold 10 is operationally configured to receive cargo 4, said cargo hold 10 having a supply plenum and a return plenum through which conditioned air may circulate, and where said plenums are located on opposite sides of said cargo hold 10; at least one air return duct 19 occurring and fluidly connecting said supply and return air plenums; a plurality of air ports (16, 18)for placing the air of said plenums in fluid connection with the air in said air return(s) 19; and a means for delivering conditioned air onto said plenums, ports and air return ducts. The cargo hold 10 may be in a cargo/carrier shipping vessel, which could be any type of boat used to ship cargo. The cargo hold may also be configured so that said supply air plenum is a lower air plenum 17 and wherein said return air plenum is an upper plenum 15. Or, one of the air plenums may be located above the cargo, and where another of said air plenums is located beneath the cargo. The opposing walls may have cell guides disposed thereon, for guiding the loading means into the cargo hold. The loading means may be from any of the group consisting essentially of the group consisting of either cassettes, flatracks, platforms, decks, traveling boards, cages, bins, or tubs. The cell guides may have retractable cantilevers. A method for conditioning air surrounding cargo 4 on a carrier vessel comprising the steps of: loading cargo 4 in the form of pallets onto a loading means; using a plurality of stanchions connected to said loading means to create and maintain air gaps between said pallets situated on said loading means; loading at least one of said loaded loading means into a cargo hold of said carrier vessel and securing a base of loading means and loaded cargo 4 along the inner walls of said cargo hold 10, wherein said base of said loading means are secured to the inner walls of said cargo hold by a securing means; stacking and securing a plurality of said loading means and loaded cargo on top on one another inside of said cargo hold; delivering conditioned air to all of said cargo (including all stacked loaded loading means) in said cargo hold via an air conditioning means. Disclosed is treatment of conditioned air with fumigation, fruit ripening gas, ozone, or a controlled atmosphere into the air cycle. Disclosed also is a method of upgrading a normal top loaded box cargo hold into a multipurpose air conditioned cargo hold comprising: (1) installing a vertical bulkhead having an upper air port and a lower air port at one side of a cargo hold 10 and establish a return air duct therebehind; (2) insulating the entire perimeter of the cargo hold, including, where practicable, the lid and floor; (3) installing a means for refrigerating said cargo; (4) providing an inventory of loading means and a means for producing an even pressure gradient and air flow between said lower air plenum and said upper air plenum through multiple tiers of said cargo; and, (5) introducing a false floor into said space. Also disclosed is a method of upgrading a normal top loaded box cargo hold into a multipurpose refrigerated cargo hold comprising: (1) installing two vertical bulkheads each having an upper air port and a lower air port at two opposing sides of a cargo hold and establishing a return air duct behind each; (2) where absent, installing corresponding cell guides on said bulkheads correspond to other cell guides on an opposite wall and thereafter positioning the installed bulkhead relative to each other to accommodate the top loading of cassettes, (3) insulating the entire perimeter of the cargo hold 10, including, where practicable, the lid and floor; (4) installing a means for refrigerating said cargo; (5) introducing a false floor into said space; (6) providing an inventory of loading means and a means for producing an even pressure gradient and air flow between said lower air plenum and said upper air plenum through multiple tiers of said cargo. Disclosed is a cargo hold 10 of a shipping vessel comprising: at least one space defined by a floor, a plurality of walls, and at least one openable lid wherein a least two of said walls oppose one another and wherein said cargo hold 10 is operationally configured to receive cargo, said cargo hold having a supply plenum and a return plenum through which conditioned air may circulate, and where said plenums are separated by a distance of at least ten feet; at least one air return duct occurring and fluidly connecting said supply and return air plenums; and a means for delivering conditioned air onto said plenums. Further disclosed is a cargo hold 10 where the distance between supply and return plenums is in a range of 10 and 80 feet.

It is to be noted, however, that the appended drawings and detailed descriptions illustrate only typical embodiments of this invention and are therefore not to be considered limiting of its scope, for the invention may admit to other equally effective embodiments that will be appreciated by those reasonably skilled in the relevant arts. Also, drawings are not necessarily made to scale but are representative.

I claim:

1. A method for shipping and conditioning air surrounding cargo on a carrier vessel comprising the steps of:
loading cargo onto a loading means;
forming a plurality of air gaps throughout the cargo in the cargo hold;
placing supply and return air plenums in fluid communication with one another;
delivering and circulating conditioned air to all of said cargo via an air conditioning means.

2. The method of claim 1 further comprising the step of loading cargo between said supply and return air plenums.

3. The method of claim 1 further comprising the step of delivering and circulating conditioned air to all of said cargo through said air gaps throughout the cargo in the cargo hold.

4. The method of claim 1 further comprising the step of circulating conditioned air through a plurality of tiers of cargo located in the same cargo hold.

5. The method of claim 1 further comprising the step of circulating conditioned air through at least two tiers of cargo.

6. The method of claim 1 wherein said cargo is palletized bananas.

7. The method of claim 1 wherein said cargo is from any of the group of produce consisting of either melons, avocadoes, fish, citrus, stone fruit, grapes, vegetables, meat, or poultry.

8. The method of claim 1 wherein said loading means is a cassette.

9. The method of claim 8 wherein said cassette has collapsible ends.

10. The method of claim 1 wherein said loading means is a flat.

11. The method of claim 1 wherein said loading means is operationally configured to allow the passage of conditioned air therethrough.

12. The method of claim 1 wherein said air gaps are formed by use of stanchions fixed to said loading means to secure cargo and define air gaps through said cargo.

13. The method of claim 1 wherein said step of inserting said loading means into said cargo hold is accomplished by guiding the loading means with cell guides located on opposing walls of said cargo hold.

14. A cargo hold comprising:
at least one space defined by a floor, a plurality of walls, and at least one openable lid wherein a least two of said walls oppose one another and wherein said cargo hold is operationally configured to receive cargo,
said cargo hold having a supply plenum and a return plenum through which conditioned air may circulate, and where said plenums are located on opposite sides of said cargo hold;
at least one air return duct occurring and fluidly connecting said supply and return air plenums;
a plurality of air ports for placing the air of said plenums in fluid connection with the air in said air return(s);
a means for delivering conditioned air onto said plenums, ports and air return ducts.

15. The cargo hold of claim 14, wherein said cargo hold is in a cargo shipping vessel.

16. The cargo hold of claim 14, wherein said supply air plenum is a lower air plenum and wherein said return air plenum is an upper plenum.

17. The cargo hold of claim 14, wherein one of said air plenums is located above said cargo, and where another of said air plenums is located beneath said cargo.

18. The cargo hold of claim 14, wherein at least two of said opposing walls have cell guides disposed thereon, for guiding loading means into said cargo hold.

19. The cargo hold of claim 14, further comprising a system that employs loading means for insertion into said cargo hold.

20. The cargo hold of claim 19, where said loading means are a cassettes.

21. The cargo hold of claim 19, wherein said loading means is from any of the group consisting essentially of either cassettes, flatracks, platforms, decks, traveling boards, cages, bins, or tubs.

22. The cargo hold of claim 18, wherein said cell guides have retractable cantilevers.

23. The cargo hold of claim 18 wherein at least one of the walls to said cargo hold features retractable cantilevers to secure and support said loading means.

24. The cargo hold of claim 14 wherein said air ducts, air ports, and air return ducts are modular and may be removed.

25. The cargo hold of claim 14, where said cargo hold is insulated.

26. The cargo hold of claim 14, wherein said cargo hold has insulation placed on the perimeter, along the exterior of the cargo hold.

27. The cargo hold of claim 14 further comprising a lower plenum defined by the void occurring between a floor of the cargo hold and the lowermost cargo stowed.

28. The cargo hold of claim 14 further comprising a lower plenum that supplies air through air port gratings in a false floor located above the cargo hold floor.

29. The cargo hold of claim 14 wherein said air flow between supply and return plenums is reversible, so that it may flow up to down and vice-versa.

30. A cargo hold on a carrier vessel comprising:
at least one space defined by a floor, a plurality of walls, and at least one openable lid wherein a least two of said walls oppose one another and wherein said cargo hold is operationally configured to receive cargo,
said cargo hold having an upper plenum and a lower plenum through which conditioned air may circulate, and where said plenums are located on opposite sides of said cargo hold;
at least two air return ducts occurring opposite one another and fluidly connecting said supply and return air plenums;
at least one upper air port located at the top of each said air return ducts for placing the air of said an upper plenum in fluid connection with the air in said air return(s);
a means for delivering conditioned air onto said plenums, ports and air return ducts.

31. The cargo hold of claim 30 wherein said means for delivering said conditioned air is at least one refrigeration unit disposed inside of said air return ducts.

32. The cargo hold of claim 30 wherein said cargo hold is configured to force conditioned air upwards through said lower plenum, through cargo, and to said upper plenum.

33. The cargo hold of claim 30 wherein the flow of air may be reversible, from the lower plenum, the upper plenum, or vice-versa.

34. A method for conditioning air surrounding cargo on a carrier vessel comprising the steps of:
loading cargo in the form of pallets onto a loading means;
Using a plurality of stanchions connected to said loading means to create and maintain air gaps between said pallets situated on said loading means;
Loading at least one of said loaded loading means into a cargo hold of said carrier vessel and securing a base of loading means and loaded cargo along the inner walls of said cargo hold, wherein said base of said loading means are secured to the inner walls of said cargo hold by a securing means;
Stacking and securing a plurality of said loading means and loaded cargo on top on one another inside of said cargo hold;
Delivering conditioned air to all of said cargo (including all stacked loaded loading means) in said cargo hold via an air conditioning means.

35. The method of claim 30 wherein the step of securing of said base of said loading means is accomplished by and through use of retractable cantilevers.

36. The method of claim 30 wherein the step of delivering said conditioned air further adds the step of introducing fruit ripening gas is introduced into said air cycle.

37. The method of claim 30 wherein the step of delivering said conditioned air further entails fumigating the cargo.

38. The method of claim 30 wherein the step of delivering said conditioned air further entails introducing ozone into said air cycle.

39. The method of claim 30 wherein the step of delivering said conditioned air further entails adding any controlled atmosphere treatment into said air-cycle

40. A multipurpose cargo hold comprising:
at least one space defined by a floor, a plurality of walls, and at least one openable lid wherein a least two of said walls oppose one another and wherein said cargo hold is operationally configured to receive cargo,
a void occurring between said lid and said cargo, after said cargo is loaded into said space, which void defines an upper air plenum;
a false floor operationally configured to permit passage of conditioned air under and therethrough, wherein a void between said false floor and another floor defines a lower air plenum;
at least one upper air port for placing the air of said upper air plenum in fluid connection with the air in an air return duct that is in fluid connection with at least one lower air port in fluid connection with the air in said lower air plenum.

41. The multipurpose cargo hold of claim 40 further comprising:
a plurality of corresponding cell guides on each of said opposing walls, wherein each of said corresponding cell guides are operationally configured to accommodate columns of stacked loading means;
a plurality of loading means operationally configured to accept cargo and permit air passage therethrough, and further configured to be top loaded and stacked into one or more tiers in said cargo hold space via said corresponding cell guides on said opposing walls.

42. The multipurpose cargo hold of claim 40 wherein said cargo hold is top loading.

43. The multipurpose cargo hold of claim 40, wherein said cargo hold is situated in a shipping vessel featuring a plurality of said cargo holds.

44. A multipurpose cargo hold comprising:
At least one space defined by a floor, a plurality of walls, and at least one openable lid wherein a least two of said walls oppose each other, and wherein at least two walls feature a plurality of upper air ports and a plurality of lower air ports fluidly connected behind each one of said two walls via at least one air return duct,
wherein said space is accessible from the top when a lid is open;
a plurality of corresponding cell guides on at least two of said opposing walls wherein each of said corresponding cell guides are operationally configured to receive cargo and permit air passage therethrough;
said walls and cell guides configured to allow top loading, securing, and stacking of cargo into one or more tiers in said space;
a void between said lid and said cargo, after said cargo is loaded into said space which defines an upper air plenum;
a false floor operationally configured to permit passage of conditioned air under and therethrough, wherein a void between said false floor and another floor defines a lower air plenum;
at least one upper air port for placing the air of said upper air plenum in fluid connection with the air in an air return duct that is in fluid connection with at least one lower air port in fluid connection with the air in said lower air plenum.

45. A carrier vessel with at least one top loading, multipurpose refrigerated cargo hold comprising:
At least one space defined by a floor, a plurality of walls, and at least one openable lid wherein a least two of said walls oppose each other and wherein at least one wall features a plurality of upper air ports and a plurality of lower air ports fluidly connected behind said wall via at least one air return duct,
said space is fully accessible from the top when the lid is open;
a plurality of corresponding paired cell guides on each of said opposing walls, wherein each of said corresponding paired cell guides are operationally configured to accommodate columns of stacked cargo;
a plurality of loading means operationally configured to accept cargo and permit air passage therethrough and further configured be top loaded and stacked into one or more tiers in said space via said corresponding paired cell guides on said opposing walls;
a void between said lid and said cargo, after said cargo is loaded into said space which defines an upper air plenum;
a false floor operationally configured to permit passage of conditioned air under and therethrough, wherein a void between said false floor and another floor defines a lower air plenum;
at least one upper air port for placing the air of said upper air plenum in fluid connection with the air in an air return duct that is in fluid connection with at least one lower air port in fluid connection with the air in said lower air plenum.
a means for refrigerating said cargo through at least one tier of said cargo.

46. The shipping vessel of claim 45 wherein said floor, said walls, and said lid are insulated.

47. The shipping vessel of claim 45 wherein said air conditioning unit is located in said air return duct.

48. The shipping vessel of claim 45 further comprising means for producing a substantially even pressure gradient and air flow.

49. The shipping vessel of claim 45 wherein said means for producing an even pressure gradient and air flow is a plurality collapsible stanchions on said cassettes that reduce movement of cargo during shipment and that maintain air gaps.

50. The shipping vessel of claim 45 wherein said corresponding paired cell guides on said opposing walls are operationally configured to accept standard ISO containers.

51. The shipping vessel of claim 45 wherein means for refrigerating said cargo is a reversible air-cycle to reduce thermal gradients within the cargo.

52. The shipping vessel of claim 45 wherein said loading means is stackable when fully loaded with cargo, and stackable when collapsed.

53. The shipping vessel of claim 45 wherein said means for securing loading means are a set of corresponding retractable cantilevers.

54. The shipping vessel of claim 45 wherein said space is divided into various temperature zones via vertical bulkheads.

55. The shipping vessel of claim 1 wherein the vertical stacking pattern is dictated by a series of retractable cantilevers positioned within said cell guide.

56. The shipping vessel of claim 45 wherein said cargo is refrigerated through multiple tiers of cargo.

57. A method of upgrading a normal top loaded box cargo hold into a multipurpose air conditioned cargo hold comprising:
(1) installing a vertical bulkhead having an upper air port and a lower air port at one side of a cargo hold and establish a return air duct therebehind;
(2) insulating the entire perimeter of the cargo hold, including, where practicable, the lid and floor;
(3) installing a means for refrigerating said cargo;
(4) providing an inventory of loading means and a means for producing an even pressure gradient and air flow between said lower air plenum and said upper air plenum through multiple tiers of said cargo; and,
(5) introducing a false floor into said space.

58. A method of upgrading a normal top loaded box cargo hold into a multipurpose refrigerated cargo hold comprising:
(1) installing two vertical bulkheads each having an upper air port and a lower air port at two opposing sides of a cargo hold and establishing a return air duct behind each;
(2) where absent, installing corresponding cell guides on said bulkheads correspond to other cell guides on an opposite wall and thereafter positioning the installed bulkhead relative to each other to accommodate the top loading of cassettes,
(3) insulating the entire perimeter of the cargo hold, including, where practicable, the lid and floor;
(4) installing a means for refrigerating said cargo;
(5) introducing a false floor into said space;
(6) providing an inventory of loading means and a means for producing an even pressure gradient and air flow between said lower air plenum and said upper air plenum through multiple tiers of said cargo

59. The method of claim 57 wherein said loading means is from any of the group consisting essential of flats or cassettes.

60. A cargo hold of a shipping vessel comprising:
at least one space defined by a floor, a plurality of walls, and at least one openable lid wherein a least two of said walls oppose one another and wherein said cargo hold is operationally configured to receive cargo,
said cargo hold having a supply plenum and a return plenum through which conditioned air may circulate, and where said plenums are separated by a distance of at least ten feet;
at least one air return duct occurring and fluidly connecting said supply and return air plenums;
a means for delivering conditioned air onto said plenums.

61. The cargo hold of claims 60, wherein the distance between supply and return plenums is in a range of 10 and 80 feet.
